(19) United States
(12) Patent Application Publication
(10) Pub. No.: US 2025/0076914 A1
(43) Pub. Date: Mar. 6, 2025

(54) VOLTAGE REGULATOR

(71) Applicant: STMicroelectronics International N.V., Geneva (CH)

(72) Inventors: Marc JOISSON, Brie et Angonnes (FR); Mounir BOULEMNAKHER, Coublevie (FR)

(73) Assignee: STMicroelectronics International N.V., Geneva (CH)

(21) Appl. No.: 18/815,142

(22) Filed: Aug. 26, 2024

(30) Foreign Application Priority Data
Aug. 30, 2023 (FR) 2309122

(51) Int. Cl. G05F 3/16

(52) U.S. Cl. CPC G05F 3/16

(57) ABSTRACT

A device includes a first MOS transistor connected between first and second nodes, a selectively activatable current source connected between the second node and a third node and a circuit configured to control the first transistor to regulate a voltage at the second node to a first set point value. The device further includes a second MOS transistor connected between the first node and a fourth node, and having its gate connected to the gate of the first MOS transistor, a third MOS transistor connected between the third and fourth nodes, a switch connected between the second and fourth nodes, and another circuit configured to control the third transistor to regulate a voltage at the fourth node to a second set point value.

### PRIORITY CLAIM

This application claims the priority benefit of French Application for U.S. Pat. No. 2,309,122, filed on Aug. 30, 2023, the content of which is hereby incorporated by reference in its entirety to the maximum extent allowable by law.

### TECHNICAL FIELD

The present disclosure generally concerns electronic circuits, for example integrated electronic circuits. The present disclosure more particularly concerns circuits configured to receive a first power supply voltage and to deliver a second power supply voltage based on the first power supply voltage, these circuits referred to, for example, as a voltage regulator.

### BACKGROUND

Many known electronic systems are powered with a first Direct Current (DC) voltage, for example received on a power supply pad of the system. To power all or part of the internal circuits that they comprise with a second DC power supply voltage of lower value than the first voltage, these known systems comprise a voltage regulator configured to generate the second DC voltage based on the first DC voltage.

In phases of use of these known systems, for example during development phases and/or during test phases at the end of the manufacturing, it may be desirable to know the current drawn by these systems from the voltage source delivering the first voltage, in order to, for example, estimate the power consumption of the internal circuits of the system which are powered with the second voltage.

In other phases of use of these known systems, for example during phases where the system is used by a final user and/or during phases where the system is deployed in its application environment, it may be desirable for the current drawn by these systems from the voltage source delivering the first voltage to be constant, in order to, for example, mask the power consumption of the internal circuits of the system powered with the second voltage. For example, this enables to avoid for attackers to access confidential information based on the knowledge of the power consumption of the circuits powered with the second voltage (a process sometimes referred to in the art as a side channel attack).

There exists a need to overcome all or part of the disadvantages of known voltage regulators.

For example, there exists a need to overcome all or part of the disadvantages of known voltage regulators configured to receive a first power supply DC voltage and to deliver a second power supply DC voltage based on the first DC power supply voltage, the second voltage having a value lower than the first one.

For example, there exists a need for a voltage regulator which can alternatively operate in a first mode where the current drawn from the voltage source delivering the first voltage varies with the current drawn by the powered circuits and in a second mode where the current drawn from the voltage source is constant.

For example, there exists a need to overcome all or part of the disadvantages of known regulators capable of alternately operating according to the first and second above-described modes.

There is a need to overcome all or part of the disadvantages of known voltage regulators.

### SUMMARY

An embodiment provides a device comprising: a first MOS transistor connected between a first node configured to receive a first power supply voltage and a second node; a selectively-activatable current source connected between the second node and a third node configured to receive a reference potential; a first circuit configured to control the first transistor to regulate a voltage of the second node to a first set point value at least partly determined by a first set point voltage; a second MOS transistor connected between the first node and a fourth node and having a gate connected to a gate of the first transistor; a third MOS transistor connected between the fourth node and the third node; a switch connected between the second and fourth nodes; and a second circuit configured to control the third transistor to regulate a voltage of the fourth node to a second set point value at least partly determined by a second set point voltage.

According to an embodiment, the fourth node is configured to deliver a second power supply voltage having a value determined by the first set point value when the switch is on and by the second set point value when the switch is off.

According to an embodiment, the first circuit comprises: a first resistive voltage dividing bridge connected between the second and third nodes; and an error amplifier configured to receive the first set point voltage and a voltage of an intermediate node of the first bridge, and to supply the gate of the first transistor with a voltage determined by the difference between the two received voltages.

According to an embodiment, the second circuit comprises: a second resistive bridge connected between the fourth and third nodes; and an error amplifier configured to receive the second set point voltage and a voltage of an intermediate node of the second bridge, and to supply the gate of the third transistor with a voltage determined by the difference between the two received voltages.

According to an embodiment, a ratio of an aspect ratio of the first transistor to an aspect ratio of the second transistor is greater than 1, preferably greater than 100, for example in the order of 300.

According to an embodiment, the device further comprises a control circuit configured to: deactivate the second circuit and the current source, and control the switch to the on state in a first operating mode; and activate the second circuit and the current source, and control the switch to the off state in a second operating mode.

According to an embodiment, the first and second circuits are configured so that the first set point value in the first mode in steady state is equal to the second set point value in the second mode in steady state.

According to an embodiment, the control circuit is further configured, during a transition from the first operating mode to the second operating mode, to successively: control the second circuit so that the second set point value is higher than the first set point value; activate the current source; control the switching of the switch to the off state to switch from the first operating mode to the second operating mode; and control the second circuit so that the second set point value is equal to the first set point value.

According to an embodiment: the first and second transistors have a channel of the same type; and the third transistor has a channel of the type opposite to that of the channel of the first and second transistors.

According to an embodiment, the first and second power supply voltages are positive with respect to the reference potential, and the first transistor has a P channel.

According to an embodiment, the current source comprises a resistive element in series with a switch between the second and third nodes.

Another embodiment provides an integrated circuit chip comprising: a device such as described hereabove; a pad configured to receive the first power supply voltage, the first power supply voltage corresponding to a power supply voltage of the chip; and an integrated circuit connected to the fourth node, the integrated circuit being configured to be powered with the voltage available on the fourth node of said device.

### BRIEF DESCRIPTION OF THE DRAWINGS

The foregoing features and advantages, as well as others, will be described in detail in the rest of the disclosure of specific embodiments given by way of illustration and not limitation with reference to the accompanying drawings, in which:

FIG. 1 schematically shows in the form of blocks an example of an integrated circuit chip comprising a voltage regulator;

FIG. 2 shows an example of a voltage regulator; and

FIG. 3 shows an example of embodiment of a voltage regulator.

### DETAILED DESCRIPTION

Like features have been designated by like references in the various figures. In particular, the structural and/or functional features that are common among the various embodiments may have the same references and may dispose identical structural, dimensional and material properties.

For the sake of clarity, only the steps and elements that are useful for the understanding of the described embodiments have been illustrated and described in detail. In particular, the various known electronic circuits capable of being used together with a voltage regulator supplying them with a power supply voltage have not been detailed, the embodiments of voltage regulator described hereafter being compatible with these known circuits.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, when reference is made to terms qualifying absolute positions, such as terms “edge”, “back”, “top”, “bottom”, “left”, “right”, etc., or relative positions, such as terms “above”, “under”, “upper”, “lower”, etc., or to terms qualifying directions, such as terms “horizontal”, “vertical”, etc., it is referred, unless specified otherwise, to the orientation of the drawings.

Unless specified otherwise, the expressions “about”, “approximately”, “substantially”, and “in the order of” signify plus or minus 10%, preferably of plus or minus 5%.

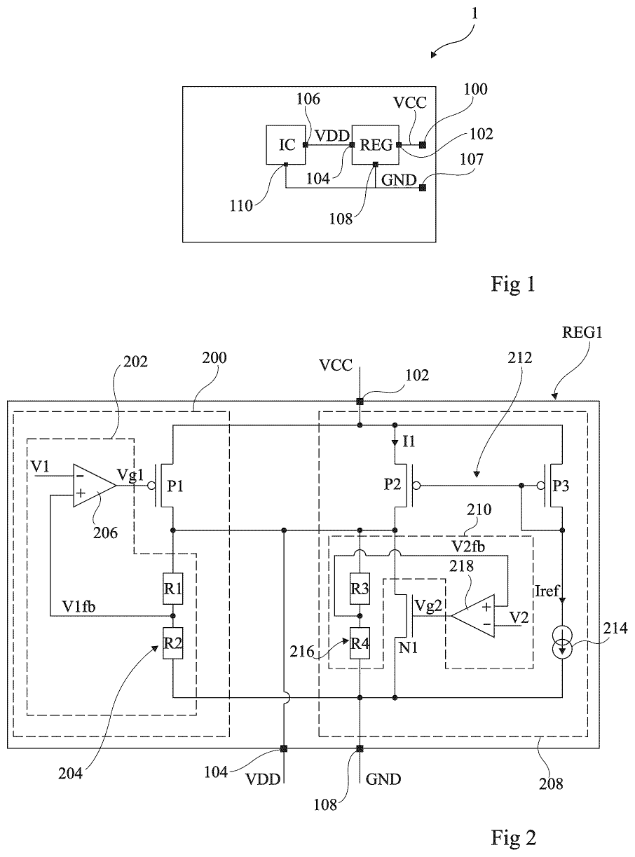

FIG. 1 schematically shows in the form of blocks an example of an integrated circuit chip 1 comprising a voltage regulator REG.

Chip 1 comprises input/output pads, each configured to receive a signal originating from the outside of chip 1 and/or to deliver a signal to the outside of chip 1. In FIG. 1, a pad 100 is configured to receive a DC power supply voltage VCC. Voltage VCC is delivered to pad 100 by a voltage source external to chip 1, and not shown in FIG. 1.

Chip 1 comprises at least one integrated circuit IC configured to be powered with a DC power supply voltage VDD, the value of voltage VDD being lower than that of voltage VCC.

For this purpose, chip 1 comprises a voltage regulator REG. Regulator REG is configured to receive voltage VCC and to deliver voltage VDD based on voltage VCC. Regulator REG thus comprises a node 102, corresponding to an input of circuit REG, configured to receive voltage VCC, and a node 104, corresponding to an output of circuit REG, configured to deliver voltage VDD. For example, the input 102 of circuit REG is connected to pad 100 of chip 1. For example, the output 104 of circuit REG is connected to an input 106 of circuit IC, input 106 being configured to receive voltage VDD for powering circuit IC.

As an example, chip 1 also comprises a pad 107 configured to receive a reference potential GND, for example the ground.

Voltages VCC and VDD are, for example, referenced to potential GND. For example, circuit REG comprises a node 108, corresponding to an input of circuit REG, configured to receive potential GND, node 108 being, for example, connected to pad 107. For example, circuit IC comprises a node 110, corresponding to an input of circuit IC, configured to receive potential GND, node 110 being, for example, connected to pad 107.

In this example, voltages VCC and VDD are positive.

As it has been previously indicated, it is desirable that, in a first operating mode REG, the current drawn by circuit REG from pad 100 to deliver voltage VDD varies with the power consumption of circuit IC; that is, varies with the current drawn from the output 104 of circuit REG by circuit IC powered with voltage VDD. It is also desirable that, in a second operating mode of circuit REG, the current drawn by circuit REG from pad 100 to provide voltage VDD is constant and thus independent from the power consumption of circuit IC powered with voltage VDD. In other words, it is desirable for circuit REG to be able to operate according to the first mode during first operating phases and according to the second operating mode during second operating phases. Still in other words, it is desirable for circuit REG to be able to operate alternately according to the first and second operating modes.

In the example of FIG. 1, only the two input/output pads 100 and 107 are shown although, in practice, chip 1 may comprise many other input/output pads.

Further, in the example of FIG. 1, only one circuit IC is powered with voltage VDD although, in other examples not illustrated, a plurality of integrated circuits of chip 1 are powered with the same voltage VDD, these circuits then all being coupled, for example connected, to the node 104 of circuit REG.

FIG. 2 shows an example of a voltage regulator REG1 capable of being used as regulator REG in chip 1.

Thus, circuit REG1 comprises node 102 configured to receive voltage VCC, node 104 configured to deliver voltage VDD, and node 108 configured to receive reference potential GND. As an example, nodes 102, 104, and 108 respectively correspond to an input, an output, and an input of circuit REG1.

Circuit REG1 further comprises a first voltage regulator 200, for example referred to herein as a series regulator. Regulator 200 is configured, when it is activated, for example by a control circuit not shown and forming part of circuit REG1, to deliver voltage VDD based on voltage VCC. Thus, regulator 200 is connected to nodes 102 and 108 to receive voltage VCC, and to node 104 to deliver voltage VDD.

Regulator 200 more particularly comprises a MOS transistor P1 and a control circuit 202 configured to control transistor P1. Transistor P1 is connected between nodes 102 and 104. For example, transistor P1 has its source connected to node 102 and its drain connected to node 104. In this example where voltages VCC and VDD are positive, transistor P1 has a P channel, or, in other words, transistor P1 is a PMOS transistor.

Circuit 202 for controlling transistor P1 is configured, when regulator 200 is active, to control transistor P1, that is to deliver a control voltage on the gate of transistor P1, so that voltage VDD is at a value equal to a set point value.

The set point value of voltage VDD, for regulator 200, is at least partly determined by a set point voltage V1. Voltage V1 is a DC voltage.

In this example, circuit 202 comprises a resistive bridge 204 connected between nodes 104 and 108. Resistive bridge 204 is configured to deliver a feedback voltage V1fb having a value determined by the value of voltage VDD. In the example of FIG. 2, resistive bridge 204 comprises two resistive elements R1 and R2 in series between nodes 104 and 108, element R1 is connected to node 104, and voltage V1fb is available on the node of connection of element R1 to element R2. In other examples, not shown, bridge 204 may comprise more than two resistive elements. When circuit 202 comprises a resistive voltage dividing bridge 204 as in FIG. 2, the resistance value of the resistive elements of bridge 204 and the intermediate node of bridge 204, that is the node of connection between two resistive elements of bridge 204, where voltage V1fb is taken determines, with voltage V1, the set point value of voltage VDD for regulator 200.

In another example, not shown, voltage VDD may be directly used as voltage V1fb and circuit 202 then comprises no bridge 204. In this case, the set point value of voltage VDD for regulator 200 is only determined by voltage V1.

Further, still in the example of FIG. 2, circuit 202 comprises an error amplifier 206 configured to deliver a voltage Vg1 having its value determined by the difference between voltages V1 and V1fb, or, more generally speaking, to deliver a voltage Vg1 having a value determined by the difference between voltage VDD and its set point value. Voltage Vg1 then is the control voltage applied by circuit 202 to the gate of transistor P1. For example, circuit 206 is implemented by an operational amplifier having an inverting input (−) receiving voltage V1, a non-inverting input (+) receiving voltage V1fb, and an output delivering voltage Vg1.

When regulator 200 is inactive, that is, controlled to be inactive or deactivated, circuit 202 is configured so that transistor P1 is off.

Circuit REG1 further comprises a second voltage regulator 208, for example referred to herein as a shunt regulator. Regulator 208 is configured, when it is activated, for example by the control circuit, not shown, to deliver voltage VDD based on voltage VCC. Thus, regulator 208 is connected to nodes 102 and 108 to receive voltage VCC, and to node 104 to deliver voltage VDD.

Regulator 208 more particularly comprises a MOS transistor N1, a control circuit 210 configured to control transistor N1, and a circuit 212 for delivering a constant current to node 104 based on voltage VCC.

Circuit 212 comprises a transistor P2 connected between nodes 102 and 104. For example, transistor P2 has its source connected to node 102 and its drain connected to node 104. In this example where voltages VCC and VDD are positive, transistor P2 has a P channel, or, in other words, transistor P2 is a PMOS transistor.

Circuit 212 is configured, when regulator 208 is active, for example when it is activated by the control circuit, not shown, to bias the gate of transistor P2 so that the current Il in transistor P2, which corresponds to the current drawn from node 102, is constant. For example, circuit 212 is configured so that current Il is equal to K times a reference current Iref, with K a positive factor. Thus, in FIG. 2, transistor P2 corresponds to the second transistor of a current mirror, transistor P2 delivering the output current of the mirror, and the other transistor P3 of the mirror receiving the current Iref supplied by a current source 214 of circuit 212. Factor K is then defined by the ratio of the aspect ratio of transistor P2 to the aspect ratio of transistor P3. Transistors P2 and P3 of course have channels of the same type, that is, P-type channels in this example.

More particularly, in the circuit 212 of FIG. 2, transistor P3 has its source connected to node 102, its gate connected to the gate of transistor P2, and its drain connected to its gate and to a terminal of current source 214, the other terminal of current source 214 being connected to node 108. In other words, transistors P2 and P3 are assembled as a current mirror, transistor P3 is series-connected with current source 214 between nodes 102 and 108, and transistor P3 has its gate and its drain connected to each other.

Transistor N1 is connected between node 104 and node 108. For example, transistor N1 has its source connected to node 108 and its drain connected to node 104. Transistor N1 has its channel of the type opposite to that of the channel of transistor P2. Thus, in this example where voltages VCC and VDD are positive, transistor N1 has an N-channel, or, in other words, is an NMOS transistor.

The control circuit 210 of transistor N1 is configured, when regulator 208 is active, to control transistor N1, that is, to deliver a control voltage on the gate of transistor N1, so that voltage VDD is at a value equal to a set point value.

The set point value of voltage VDD, for regulator 208, is at least partly determined by a set point voltage V2. Voltage V2 is a DC voltage.

In this example, circuit 210 comprises a resistive bridge 216 connected between nodes 104 and 108. Resistive bridge 216 is configured to deliver a feedback voltage V2fb having a value determined by the value of voltage VDD. In the example of FIG. 2, resistive bridge 216 comprises two resistive elements R3 and R4 in series between nodes 104 and 108, element R3 is connected to node 104, and voltage V2fb is available on the node of connection of element R3 to element R4. In other examples, not shown, bridge 216 may comprise more than two resistive elements. When circuit 210 comprises a resistive voltage dividing bridge 216 as in FIG. 2, the resistance value of the resistive elements of bridge 216 and the intermediate node of bridge 216, that is, the node of connection between two resistive elements of bridge 216, where voltage V2fb is taken determines, with voltage V2, the set point value of voltage VDD for regulator 208.

In another example, not shown, voltage VDD may be directly used as voltage V2fb and circuit 210 then comprises no bridge 216. In this case, the set point value of voltage VDD for regulator 208 is only determined by voltage V2.

Further, still in the example of FIG. 2, circuit 210 comprises an error amplifier 218 configured to deliver a voltage Vg2 having a value determined by the difference between voltages V2 and V2fb, or, more generally speaking, to deliver a voltage Vg2 having a value determined by the difference between voltage VDD and its set point value. Voltage Vg2 then is the control voltage applied by circuit 210 to the gate of transistor N1. For example, circuit 218 is implemented by an operational amplifier having an inverting input (−) receiving voltage V2, a non-inverting input (+) receiving voltage V2fb, and an output delivering voltage Vg2.

When regulator 208 is inactive, that is, controlled to be inactive or deactivated, circuit 212 is configured so that transistor N1 is off, and, further, current source 214 is deactivated, or, in other words, turned off.

The circuit, not shown, for controlling regulators 200 and 208, which forms part of regulator REG1, is configured to: activate regulator 200 and deactivate regulator 208 when circuit REG1 is in a first operating mode where the current drawn from node 102 varies with the variations of the power consumption of a load connected to node 104; and activate regulator 208 and deactivate regulator 200 when circuit REG1 is in a second operating mode where the current drawn from node 102 has to be constant whatever the variations of the power consumption of a load connected to node 104.

Circuit REG1 thus effectively enables to deliver voltage VDD based on voltage VCC, so that the current drawn from node 102 varies with the power consumption of the loads powered with voltage VDD in a first operating mode, and so that the current drawn from node 102 is constant and independent from the power consumption of the loads powered with voltage VDD in a second operating mode.

However, for this purpose, the regulator comprises two transistors P1 and P2, relatively large and bulky with respect to transistor P3. Indeed, these transistors P1 and P2 have to be able to conduct between their terminals the maximum current that voltage source VCC can deliver to node 102, and thus to node 104. For example, for a given application, this maximum current may have a maximum value in the order of 20 mA.

It would thus be desirable to have a voltage regulator REG2 allowing the same operation as regulator REG1 but with a decreased bulk.

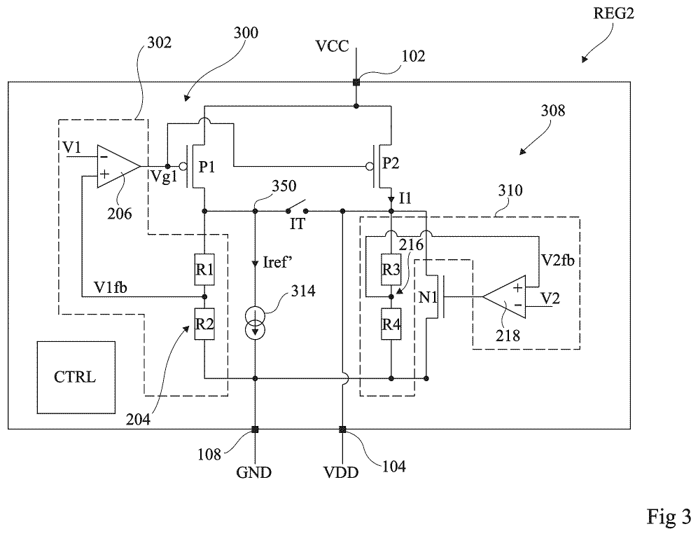

FIG. 3 shows an example of embodiment of such a voltage regulator REG2.

Regulator REG2 comprises elements in common with the regulator REG1 of FIG. 2. Thus, unless indicated otherwise, for a same element forming part of each of regulators REG1 and REG2, all that has been indicated for this element when it forms part of regulator REG1 applies to this element when it forms part of regulator REG2. Further, only the differences between regulators REG1 and REG2 are here highlighted.

Regulator RGE2 thus comprises nodes 102, 108, and 104.

Regulator REG2 comprises a series voltage regulator 300 identical to the previously-described regulator 200. Thus, regulator 300 comprises MOS transistor Pl and a circuit 302 for controlling transistor P1. Circuit 302 is, for example, identical to the previously-described circuit 202. For example, circuit 302 comprises resistive voltage dividing bridge 204 and circuit 206.

However, while, in regulator 200, transistor PI is connected between nodes 102 and 104, in this embodiment, the transistor P1 of regulator 300 is connected between node 102 and an intermediate node 350.

Further, while circuit 302 comprises bridge 204, this bridge 204 is connected between nodes 350 and 108 rather than between nodes 104 and 108 as is the case in circuit REG1.

Regulator REG2 further comprises a shunt voltage regulator 308 similar to regulator 208 in that it comprises: transistor P2, connected between nodes 102 and 104; transistor N1, connected between nodes 104 and 108; a circuit 310 for controlling transistor N1, for example identical to control circuit 210, delivering voltage Vg2 to the gate of transistor N1; and a current source 314.

However, regulator 308 differs from regulator 208 in that: current source 314 is connected between nodes 350 and 108; regulator 308 comprises no transistor P3; and current source 314 is configured, when it is activated, for example by a control circuit CTRL forming part of circuit REG2 and being configured to control regulators 300 and 308, to deliver a current Iref.

Indeed, it is here provided, when regulator 308 is active, to use the current source and to reuse regulator 300 to bias the gate of transistor P2, so that constant current Il flows between the terminals of transistor P2.

For this purpose, regulator REG2 further comprises a switch IT coupling node 350 to node 104. In other words, switch IT has a conduction terminal connected to node 350 and another conduction terminal connected to node 104. Switch IT is, for example, controlled by circuit CTRL. For example, switch IT is controlled to the on state when regulator 308 is inactive, and to the off state when regulator 308 is active.

Further, current source 314 is selectively activatable. In other words, the current source is alternately controlled to a state where it delivers current Iref, current source 314 then being on or activated, and to a state where it does not deliver current Iref, current source 314 then being called deactivated or off. As an example, current source 314 is controlled by circuit CTRL. For example, current source 314 is controlled to the active state when regulator 308 is active, and to the inactive state when regulator 308 is inactive.

In regulator REG2, when regulator 300 is active, regulator 308 is inactive, that is, circuit 310 is deactivated and then controls transistor N1 to the off state and, further, current source 314 is controlled to the deactivated state. In this first operating mode where regulator 300 is active and regulator 308 is inactive, switch IT is controlled to the on state.

As an example, in this first operating mode, to limit current leaks in bridge 216, it is provided for the resistive element R4 of bridge 216 to have a controllable resistance value, and element R4 is then controlled to have its maximum resistance value, preferably so that element R4 is equivalent to an open circuit.

As a variant, when regulator 308 is inactive, it is possible to provide a switch controlled to the off state when regulator 308 is inactive, and to the on state when regulator 308 is active. This switch may be arranged between node 104 and transistor N1. However, when regulator 308 is active, this may result in significant voltage drops across this switch, which is not desirable. This switch may also be arranged in series with bridge 216 between nodes 104 and 108. However, here again, this may result in significant voltage drops across this switch, which is not desirable.

Further, in regulator REG2, when regulator 308 is active, regulator 300 is inactive. In this second operating mode where regulator 308 is active, current source 314 is controlled to the active state, and switch IT is controlled to the off state. However, conversely to circuit REG1 where circuit 202 controls transistor P1 to the off state when regulator 200 is inactive, in circuit REG2, control circuit 302 keeps on operating and controlling transistor Pl so that the voltage on node 350 is regulated to the set point value of regulator 300.

In the first operating mode, transistors P1 and P2 are connected in parallel between nodes 102 and 104, 350. The two transistors Pl and P2 thus deliver together a current to node 104 and circuit 302 controls transistor P1, and thus transistor P2, so that voltage VDD is regulated to the set point value of regulator 300, the latter being at least partly determined by the value of voltage V1.

In the second operating mode, when the set point value of voltage VDD for regulator 308 is equal to the set point value of voltage VDD for regulator 300, which is the case in steady state, for example by providing for voltages V1 and V2 to be equal, and that ratio R1/R2 is equal to ratio R3/R4, then the voltage on node 350 is regulated to the same value as the voltage VDD on node 104. Since transistors P1 and P2 have the same gate voltage Vg1 and have the same source voltage VCC, transistor P2 delivers current Il at a value determined by the current flowing through transistor Pl and by the ratio of the aspect ratio of transistor P2 to the aspect ratio of transistor P1. Now, the current in transistor P1 when regulator 300 is inactive, that is, it does not directly regulate the voltage VDD on node 104, the current in transistor Pl is equal to current Iref if the current in bridge 204 is neglected, or to the sum of current Iref and of the current in bridge 204 if the current in bridge 204 is not neglected, this current being then being substantially equal to VDD/(R1+R2) in the example of FIG. 3. Thus, the current Il in transistor P2 is effectively equal to K times the current in transistor P1, with K determined by the dimension ratio between transistors P1 and P2.

For example, the ratio of the aspect ratio of transistor Pl to the aspect ratio of transistor P2 is positive and for example greater than 100, preferably greater than or equal to 300,for example equal to approximately 300. Thereby, the current Il in transistor P2 when regulator 308 is active is greater than the current in transistor P1, for example greater than 100 times the current in transistor P1, preferably greater than or equal to 300 times the current in transistor P1, for example equal to approximately 300 times the current in transistor P1.

Thus, in circuit REG2, transistor P2 has dimensions similar, or even identical, to those of transistor P2 of circuit REG 1 for same values of current 11, and transistor Pl is then smaller than the transistor P1 of circuit REG1, and smaller than the transistor P2 of circuit REG2. Circuit REG2 thus comprises one less large transistor than circuit REG1, and is thus less bulky.

According to an embodiment, due to the fact that, in the second operating mode, the voltage on node 350 is equal to the regulated voltage VDD on node 104, current source 314 may be implemented by a resistor R, current Iref then being equal to VDD/R. As an example, this resistor is in series with a switch controlled to the on, respectively off, state, when source 314 is controlled to the on, respectively off, state. As an alternative example, resistor R is a resistor having a controllable value and is controlled to its maximum value corresponding, preferably, to an open circuit, when source 314 is controlled to the inactive state.

According to an embodiment, to avoid cross conductions between the two regulators 300 and 308 during a transition from the first operating mode to the second operating mode, the following method is implemented, for example by circuit CTRL.

At an initial step, regulator 300 is active and regulator 308 is inactive. Switch IT is thus on, current source 314 is inactive or off, and circuit 310 controls transistor N1 to the on state.

At a next step, the set point value of voltage VDD for regulator 310 is modified so that, when regulator 308 will be switched to the active state, it will try to regulate the voltage on node 104 to a value higher than the value to which regulator 300 regulates voltage VDD on node 104. In other words, the set point value of voltage VDD for regulator 308 is set to a value higher than the set point value of voltage VDD for regulator 300. As a result, transistor N1 is then controlled to the off state by circuit 310.

As an example, the set point value for voltage VDD for regulator 308 is modified by correspondingly modifying the value of voltage V2.

As an alternative example, in an embodiment where the two bridges 204 and 216 are identical and where voltage V1fb is taken from an intermediate node of bridge 204 corresponding to the intermediate node of bridge 216 from which voltage V2fb is taken, to avoid having to generate two different set point voltages V1 and V2, the set point value of voltage VDD for regulator 308 is modified by modifying the resistance value of one of the resistive elements of bridge 216. For example, when voltages V1 and V2 are equal and elements R1 and R3 have a same resistance value, if elements R2 and R4 have the same resistance value, the set point values of voltage VDD are the same for the two regulators 300 and 308, and, if resistive element R4 has a smaller resistance value than that of resistive element R2, then the set point value of voltage VDD for regulator 308 will be higher than that for regulator 300.

At a next step, current source 314 is switched to the active state and starts delivering current Iref.

At a next step, regulator 308 is switched to the active state. Since its set point value of voltage VDD is higher than that for regulator 300, as it has been previously indicated, transistor N1 remains controlled to the off state.

Regulator 300 is then switched to the deactivated state by turning off switch IT. As a result, the voltage VDD on node 104 increases to reach the set point value of voltage VDD for regulator 308.

Before voltage VDD reaches this set point value or when voltage VDD reaches this set point value, the set point value of voltage VDD for regulator 308 is modified again to be equal to the set point value of voltage VDD for regulator 300.

It should be noted that the embodiment of a method of transition from the first operating mode to the second operating mode described for circuit REG2 may be adapted and implemented in the example of circuit REG1 described in relation with FIG. 2, for example as follows.

At an initial step, regulator 200 is active and regulator 208 is inactive.

At a next step, the set point value of voltage VDD for regulator 208 is set to a value higher than the set point value of voltage VDD for regulator 200.

At a next step, regulator 208 is switched to the active state. Due to the fact that the set point value of voltage VDD for regulator 208 is higher than the set point value of voltage VDD for regulator 200, transistor N1 is held off by circuit 210.

At a next step, regulator 200 is switched to the inactive state. As a result, the voltage VDD on node 104 increases to reach the set point value of voltage VDD for regulator 208.

Before voltage VDD reaches this set point value or when voltage VDD reaches this set point value, the set point value of voltage VDD for regulator 208 is modified again to be equal to the set point value of voltage VDD for regulator 200.

Various embodiments and variants have been described. Those skilled in the art will understand that certain features of these various embodiments and variants may be combined, and other variants will occur to those skilled in the art. In particular, although examples where voltages VCC and VDD are positive and transistors Pl and P2 then have a P channel while transistor N1 has an N channel have been described, in other examples not illustrated, voltages VDD and VCC are negative, voltage VDD being smaller, in absolute value, than voltage VCC. In this case, transistors P1 and P2 have an N channel and transistor N1 has a P channel. Those skilled in the art will be capable of adapting, if need be, the implementation of circuits 302 and 310, for example by inverting the voltages entering the inverting and non-inverting inputs of circuits 206 and 218 if necessary.

Further, although this has not been detailed, according to an embodiment, regulator REG2 is implemented in chip 1, instead of regulator REG.

Finally, the practical implementation of the described embodiments and variants is within the abilities of those skilled in the art based on the functional indications given hereabove.

1. A device, comprising:
a first MOS transistor connected between a first node configured to receive a first power supply voltage and a second node;
a selectively activatable current source connected between the second node and a third node configured to receive a reference potential;
a first circuit configured to control the first transistor to regulate a voltage of the second node to a first set point value at least partly determined by a first set point voltage;
a second MOS transistor connected between the first node and a fourth node;
wherein a gate of the second MOS transistor is connected to a gate of the first MOS transistor;
a third MOS transistor connected between the fourth node and the third node;
a switch connected between the second and fourth nodes; and
a second circuit configured to control the third transistor to regulate a voltage of the fourth node to a second set point value at least partly determined by a second set point voltage.

2. The device according to claim 1, wherein the fourth node is configured to deliver a second power supply voltage having a value determined by the first set point value when the switch is on, and by the second set point value when the switch is off.

3. The device according to claim 1, wherein the first circuit comprises:
a first resistive voltage dividing bridge connected between the second node and the third node; and
an error amplifier configured to receive the first set point voltage and a voltage of an intermediate node of the first resistive voltage dividing bridge, and to supply the gate of the first MOS transistor with a voltage determined by the difference between the two received voltages.

4. The device according to claim 1, wherein the second circuit comprises:
a second resistive voltage dividing bridge connected between the fourth node and the third node; and
an error amplifier configured to receive the second set point voltage and a voltage of an intermediate node of the second resistive voltage dividing bridge, and to supply the gate of the third MOS transistor with a voltage determined by the difference between the two received voltages.

5. The device according to claim 1, wherein a ratio of an aspect ratio of the first MOS transistor to an aspect ratio of the second MOS transistor is greater than 1.

6. The device according to claim 1, wherein a ratio of an aspect ratio of the first MOS transistor to an aspect ratio of the second MOS transistor is greater than 100.

7. The device according to claim 1, wherein a ratio of an aspect ratio of the first MOS transistor to an aspect ratio of the second MOS transistor is in the order of 300.

8. The device according to claim 1, further comprising a control circuit configured to:
deactivate the second circuit and the current source, and control the switch to the on state in a first operating mode; and
activate the second circuit and the current source, and control the switch to the off state in a second operating mode.

9. The device according to claim 8, wherein the first circuit and second circuit are configured so that the first set point value in the first mode in steady state is equal to the second set point value in the second mode in steady state.

10. The device according to claim 9, wherein the control circuit is further configured, during a transition from the first operating mode to the second operating mode, to successively:
control the second circuit so that the second set point value is higher than the first set point value;
activate the current source;
control the switching of the switch to the off state to switch from the first operating mode to the second operating mode; and
control the second circuit so that the second set point value is equal to the first set point value.

11. The device according to claim 1, wherein:
the first and second MOS transistors have a channel of the same type; and
the third MOS transistor has a channel of the type opposite to that of the channel of the first and second MOS transistors.

12. The device according to claim 11, wherein the first and second power supply voltages are positive with respect to the reference potential, and the first MOS transistor has a P channel.

13. The device according to claim 1, wherein the selectively activatable current source comprises a resistive element in series with a switch between the second and third nodes.

14. An integrated circuit chip, comprising:
the device according to claim 1;
a pad configured to receive the first power supply voltage, the first power supply voltage corresponding to a power supply voltage of the integrated circuit chip; and
an integrated circuit connected to fourth node, the integrated circuit being configured to be powered with the voltage available on the fourth node of said device.

15. A device, comprising:
a series regulator circuit having a first input coupled to a supply voltage node, a first output node where a first regulated voltage is output, and a second input node coupled to a ground node;
a shunt regulator circuit having an input coupled to the supply voltage node, a second output node where a second regulated voltage is output, and a second input node coupled to the ground node;
a switch selectively connecting the first output node to the second output node;
a selectively activatable current source coupled between the first output node and the ground node; and
a control circuit configured to control operation of the device by:
enabling the series regulator circuit, enabling the selectively activatable current source and closing the switch to provide a regulated output voltage of the device from the series regulator circuit; and
enabling the shunt regulator circuit and opening the switch to provide the regulated output voltage of the device from the shunt regulator circuit.

16. The device of claim 15:
wherein the series regulator circuit includes a first MOS transistor coupled between the supply voltage node and the first output node;
wherein the shunt regulator circuit includes a second MOS transistor coupled between the supply voltage node and the second output node; and
wherein a gate of the second MOS transistor is connected to a gate of the first MOS transistor.

17. The device of claim 16, wherein the first regulated voltage is controlled by a voltage applied to the gate of the first MOS transistor by a first error amplifier circuit.

18. The device of claim 17:
wherein the shunt regulator circuit further includes a third second MOS transistor coupled between the second output node and the ground node; and
wherein the second regulated voltage is controlled by a voltage applied to the gate of the third MOS transistor by a second error amplifier circuit.

19. The device according to claim 16, wherein a ratio of an aspect ratio of the first MOS transistor to an aspect ratio of the second MOS transistor is greater than 1.

20. The device according to claim 16, wherein a ratio of an aspect ratio of the first MOS transistor to an aspect ratio of the second MOS transistor is greater than 100.

21. The device according to claim 16, wherein a ratio of an aspect ratio of the first MOS transistor to an aspect ratio of the second MOS transistor is in the order of 300.

22. The device according to claim 15, wherein the selectively activatable current source comprises a resistive clement in series with a switch between the first output node and the ground node.
